(19) United States
(12) Patent Application Publication
(10) Pub. No.: US 2024/0029181 A1
(43) Pub. Date: Jan. 25, 2024

(54) SYSTEMS AND METHODS FOR INFERRING ASSET TYPES WITH MACHINE LEARNING FOR COMMERCIAL REAL ESTATE

(71) Applicant: Scryer, Inc. dba Reonomy, New York, NY (US)

(72) Inventors: Carlos Espino Garcia, Astoria, NY (US); Mehdi Berrada Mnimene, New York, NY (US); Liang Li, Norfolk, VA (US); Maureen Teyssier, Hawthorne, NJ (US)

(21) Appl. No.: 18/274,751

(22) PCT Filed: Jan. 28, 2022
(86) PCT No.: PCT/US2022/014383

§ 371 Date: Jul. 28, 2023

Related U.S. Application Data
(60) Provisional application No. 63/143,749, filed on Jan. 29, 2021.

(51) Int. Cl. G06Q 50/16

(52) U.S. Cl. CPC G06Q 50/16

(57) ABSTRACT

Systems, methods, and a computer readable storage medium for inferring asset types are provided. A method for determining asset types of one or more properties includes collecting, with a processor in communication with a memory, data related to the one or more properties and extracting features of the one or more properties from the data. The method includes determining a binary classifier for each asset type of a set of asset types and outputting each asset type of the one or more properties.

### CROSS REFERENCE TO PRIOR APPLICATION

This application claims the benefit of U.S. Provisional Patent Application No. 63/143,749, entitled as “SYSTEMS AND METHODS FOR INFERRING ASSET TYPES WITH MACHINE LEARNING FOR COMMERCIAL REAL ESTATE”, filed Jan. 29, 2021, which is incorporated by reference in its entirety.

### FIELD OF THE INVENTION

This disclosure relates to the field of data collection and processing for properties, organizations, and individuals.

### BACKGROUND

In the industry of commercial real estate, most industry professionals, including sales and debt brokers, individual and institutional investors, property managers, REITs, strategic buyers for tax offsets, construction professionals, etc. specialize around one or a few asset (property) types. The asset type is the functional type of the property, e.g. retail, industrial, office, etc. Therefore the “asset type” is probably the most important thing we can know about a property, other than its location. Without the asset type, potential assets are not discovered, property ownership portfolios, and their owners are not properly identified or discovered, and generally revenue opportunities are lost—primarily for the industry professionals who would have benefitted from the information, but also for any platforms that are trying to provide actionable information to the industry professionals.

Data on commercial real estate (the land, the structures, the associated people, and the transactional history) are collected by humans who are filling the function of local tax assessors offices, of which there are over 3,100 across the U.S. This data is collected at the tax parcel level, meaning that the asset type, and other history or ownership characteristics are collected at this level. The relationship between the tax parcel and its structures (buildings, parking lots, etc) can be 1 to 1, 1 to many, or many to 1. When referring to asset type predictions on a property, reference is made to predictions at the property level. Because the data is collected by humans, and because the data is collected in widely varying formats, mistakes in the data are common and errors are very common. Many millions of properties have an incorrect, missing, or have an unusably general asset type designation. When properties are categorized as “Commercial General”, they are basically unclassified. This leads to potential lost revenue as described above.

Previous methods of gathering the information includes traveling to the physical location, which is not scalable on a national level. It also includes relying on the data from the tax assessor's office, which is often missing or inaccurate.

### SUMMARY

The disclosed subject matter is a method and system for inferring asset types of properties. A general aspect is a method of determining asset types of one or more properties. The method includes collecting data, with a processor in communication with a memory, related to the one or more properties and extracting features of the one or more properties from the data. The method includes determining, by the processor, a binary classifier for each asset type of a set of asset types. The method includes outputting, by the processor, each asset type of the one or more properties. The extracting may include determining one or more words in a description. Determining the binary classifier may include determining a probability that each asset type is attached to a property. The features may include asset types of neighboring properties. The features may include aggregates of features from two or more neighboring properties. The asset types of neighboring properties may be determined by estimating a multinomial distribution over all asset types. The binary classifier may be trained by a machine learning algorithm.

An exemplary embodiment is a computing system, with a processor attached to a memory, for determining asset types of one or more properties. The computing system includes a processing server configured to collect data related to the one or more properties where the processing server is configured to extract features of the one or more properties from the data. The processing server is configured to determine a binary classifier for each asset type of a set of asset types. The processing server is configured to output each asset type of the one or more properties. The extracting may include determining one or more words in a description. Determining the binary classifier may include determining a probability that each asset type is attached to a property. The features may include asset types of neighboring properties. The features may include aggregates of features from two or more neighboring properties. The asset types of neighboring properties may be determined by estimating a multinomial distribution over all asset types. The binary classifier may be trained by a machine learning algorithm.

Another general aspect is a computer readable storage medium, connected to a processor and a memory through a bus, having data stored therein representing a software executable by a computer. The software includes instructions that, when executed, cause the computer to perform collecting data related to one or more properties and extracting features of the one or more properties from the data. The software includes instructions that cause the computer to perform determining a binary classifier for each asset type of a set of asset types. The outputting comprises a display of a geographic map with the one or more properties selectable by a user. Extracting may include determining one or more words in a description. Determining the binary classifier may include determining a probability that each asset type is attached to a property. The features may include asset types of neighboring properties. The features may include aggregates of features from two or more neighboring properties. The asset types of neighboring properties may be determined by estimating a multinomial distribution over all asset types and the binary classifier may be trained by a machine learning algorithm.

### BRIEF DESCRIPTION OF THE DRAWINGS

FIG. 1 illustrates an exemplary embodiment of the disclosed subject matter for inferring asset types.

FIG. 2 is a flow diagram for a process of determining asset types for a property.

FIG. 3A is a block diagram of a process for feature extraction from a property.

FIG. 3B is a block diagram for a process for asset types model training.

FIG. 3C is a block diagram showing a generalized process for a binary classifier training pipeline for a particular asset type.

FIG. 3D is a block diagram of a process for model inference.

FIG. 4 is a model for hyperparameter tuning.

FIG. 5 is a process for extracting property features by estimating a multinomial distribution over asset types of other properties.

FIG. 6 is a block diagram of a process for extracting NAICS and SIC code features from a multitude of databases.

FIG. 7 is a block diagram of a legal description feature extraction.

FIG. 8 is an illustration of a computer system 800 that may perform the disclosed process of inferring asset types.

FIG. 9 is a screen shot illustrating how asset types may be displayed in a user interface to understand the characteristics of a property.

FIG. 10 is a screen shot of an exemplary embodiment of a user interface that presents the asset types for an entity such as a corporation or an individual.

FIG. 11 is a screen shot of an exemplary embodiment of a user interface that presents the asset types for an entity such as a corporation or an individual.

FIG. 12 is a screen shot of a browser view of multifamily asset types.

FIG. 13 is a screen shot of a browser view of industrial asset types.

FIG. 14 is a screen shot of a browser view of commercial asset types.

FIG. 15 is a screen shot of a browser view of other asset types.

FIG. 16 is a screen shot of a browser view of a vacant land asset types.

FIG. 17 is a screen shot of a browser view of special purpose asset types.

### DETAILED DESCRIPTION

The disclosed subject matter is a method and system that leverages machine learning modeling to determine the asset type on a per-property basis. The asset types are determined based on other information or features about the property, the property's owner and lender, the history of the property, the tax valuation, the neighborhood, human population information, tenant information, and the behavior of the asset type in the market and in the local area at different levels of granularity.

The disclosed system identifies the asset type of a property. The identified asset type allows the system to provide more potential opportunities for business revenue than they otherwise would have had available. For example, an asset type of a property may be leveraged to infer an asset type of neighboring properties. Similarly, an asset type of a property may be leveraged to infer additional asset types for the same property. Also, an asset type of a property may be leveraged to infer asset types for other properties with the same owner or properties within the same complex.

In an exemplary embodiment, the system for inferring asset types of properties includes a computing server that collects data from various sources. The sources include intrinsic property information about a property. The intrinsic property information may include property features such as the assessor value to most recent sale ratio, the assessed improvement value, the assessed land value, the assessed total value, the lot size depth in feet, the lot size frontage in feet, the market value for improvements, the market value for the land, the sum of commercial units, the sum of residential units, the building area, the number of floors, the lot size in square feet, the total market value, the number of buildings, the tax amount, the total number of units, the year the property was built, the effective year that it was built, the sum number of full baths, the sum number of half baths, the sum number of quarter baths, the sum number of rooms, the sum number of three quarter baths, the total number of baths, the longitude and latitude of the property, the number of tenants, the percentage of commercial units, the percentage of residential units, the tenants per building area, the tenants per lot size, the floors times buildings, the area to floors to buildings, the area to floors, the building area to lot size square foot ratio, the building area per unit, the floors per unit, the tax per unit, the lot size per unit, the market value per unit, the building per lot per unit, and the building and land characteristics from image data.

In addition to intrinsic information about a property, several other features are considered to determine an asset type. Among those are neighborhood asset types. For each property, asset types of the k closest properties are extracted by estimating a multinomial distribution over the asset types. For example, a 10-dimensional vector of probabilities may be created for each asset type. The sum over the 10-dimensional vector may be 1. In an exemplary embodiment, Bayesian inference is used to estimate the parameters of the distribution. The Bayesian inference may increase the uncertainty when there are a small number of neighbors in order to reflect enough uncertainty to make an inference. Because of the large scale of the data, the closest properties may be found using geohashing. The system may map each property using longitude and latitude, to the property's corresponding hash. The system may search for the closest properties corresponding to the same hash.

Additionally, aggregates from properties in the neighborhood may be considered to determine an asset type. For instance, the combined feature of the k closest neighboring properties may be considered. Various aggregate features that may be considered to determine an asset type are the average total units, the average building area, the average number of floors, the average market total value, the average tax amount, the average lot size per square foot, the average building area per unit, the average floors per unit, the average market value per unit, the average tax per unit, the average lot size per unit, the average building per lot per unit, the property market value to average ratio, the property tax amount to average ratio, the property building area to average ratio, the property lot size to average ratio, the property number of floors to average ratio, the property number of floors per unit to average ratio, the property market value to average ratio, and the property tax amount to average ratio.

And additionally, census information may be considered to determine asset types. In one example, the system may use population and household information to identify rural vs. urban areas for each census tract.

Additionally, SIC and NAICS codes for tenants may be considered to determine asset types. In an exemplary embodiment, a tenant's business activity may be a key factor to determine an asset type. This business activity information may be captured by the NAICS and SIC industry classification systems. To extract the signal, the disclosed subject matter may use the descriptions provided by the classification system and map each word to a pre-trained embeddings model and compute the average of the embeddings for each word to create an overall sentence embedding of the dimension of the original word embeddings. In an exemplary embodiment, the embeddings model is GloVe embeddings, whose dimension is 50.

Additionally, asset types of other properties that belong to the owner may be considered to determine the asset type of a property. For example, the system may extract the asset types of other properties from the same owner by estimating a multinomial distribution over the asset types for each property. The estimation of the parameters for the multinomial distribution may follow the same logic as the neighborhood asset types.

Additionally, the legal description of the property may be considered to determine the asset type of the property. The purpose of using the legal description is to extract words from the legal description that are closely related to asset types and then estimate the probability of a property to have an asset type given these words. In an exemplary embodiment, the Correspondence Analysis algorithm may be used to compute the association between words and asset types. In one example, the system may remove the words from the legal description that are not in the set of words defined in the estimating step above. The remaining words may be represented as features using a TF-IDF vectorizer trained one 1-gram, 2-grams, and 3-grams. The system may use these features to estimate the probability of a property legal description to correspond to a certain asset type. These features may be used to estimate the probability of a property legal description to correspond to a certain asset type. In various embodiments, this probability is estimated by training a One-Versus-Rest model for each asset type using the word representation for each property. Various binary classifiers may be used as the model inside the One-Versus-Rest model. In an exemplary embodiment, a lightGBM model may be used as the classifier for the Once-Versus-Rest model. The final output may be a vector of dimension 10, which corresponds to the probability for each asset type.

Additionally, zoning codes may be considered in determining the asset types of properties. Zoning codes are highly related to asset types. However, zoning code definitions and codes vary by county which makes it harder to systematically extract signals from them. To extract a relationship between asset types and zoning codes, the system may use corresponding analysis using a combination of zoning code, state, and county with the asset types. The asset inferring system may use the scores of the correspondence analysis as a set of features for the model.

Additionally, asset types of other properties corresponding to the same multi-tax-parcel property compound may be considered to determine asset types. The asset inferring system may extract the asset types of other properties that belong to the same compound by estimating a multinomial distribution over the asset types. The estimation of the parameters may follow the same logic as the Neighborhood asset types.

Data is collected from various databases. The various databases may have dissimilar types of data and store the data in different formats. Thus, the asset inferring system may use multiple feature extraction components for different types of features and for different databases. The feature extraction components are necessary for both model training and also run in production. In some cases, subroutines perform more complex or lengthy feature extraction, as in the case of NAICS and SIC code feature extraction, in the case of legal description feature extraction, and in the case of multi-parcel asset type feature extraction.

Other potential features that may be used in the asset inferring system include a type of point-of-interest that corresponds to a property, a distance to a point of interest, a distance to transportation systems, and extracted property characteristics from satellite and street view images. Examples of a type of a point-of-interest include coffee shops, parks, and the beach. Further, the distance of a property to points-of-interest may be used as a feature to infer asset types. Examples of the distance to transportation systems may be a distance to a subway, distance to a bus, distance to a train station, and distance to a freeway.

The potential feature of using extracted property characteristics from satellite and street view images may automatically ascertain property characteristic information based on images of the properties. The images may be collected from systematic image taking systems such as satellite images or street view images. In an exemplary embodiment, a machine learned algorithm may be trained to ascertain property characteristics based on the images. Examples of machine learning algorithms that may be implemented for training may be neural networks such as convolutional neutral networks or transformer architectures.

The asset inferring system may include a model that classifies properties based on the extracted features. The classification model may be a binary classifier that determines whether the property is an asset type. Further, the classification model may include multiple binary classifiers, one for each asset type. Given that a property can have one or more asset types, the classification model is a multi-label classification model. This means that the asset inferring system may train individual binary classification models for each asset type. The asset inferring system may use the multiple trained binary classification models to predict multiple asset types. In an exemplary embodiment, each individual classification model may determine that a property is an asset type if an independent score for that asset model is higher than a certain threshold.

Thresholds may be selected for each binary classifier to predict asset types. For example, a metric of 90% precision may be set as a target threshold. In various embodiments, metrics other than precision may be used. Similarly, the percentage may be set to any x %.

The product of the asset type inferring system has the flexibility to capture real-world scenarios e.g. the retail wing of a transportation hub. The asset type inferring system may also characterize a property as “none of the above” for properties that fail to meet the required threshold for any asset type. Separate training pipelines are run for each asset type. The separate training pipelines may be generic in form. Further, the separate training pipelines may include a hyperparameter tuning component. As such, there may be a binary classifier for each asset type. Once a trained binary classifier model has been created for each asset type, these models can be used to ingest data from the feature extraction components on new data in production to supply the necessary data for the model to perform predictions which are then supplied to the API and the website.

Various binary classification algorithms may be used for the multi-label framework. In various embodiments, classifiers for the task should have a scalable training algorithm so it can benefit from up to millions of data points. Further, the classifiers should scale to millions of points during inference. For instance, it should be parallelizable, run fast, and use low amounts of memory when applied. And further, the classifiers should preferably handle null values and perform with high accuracy in practice.

In an exemplary embodiment, a tree-based gradient boosting algorithm may be used to train the separate binary classifiers. The tree-based gradient boosting algorithm may be advantageous because it scales well, achieves state-of-the-art performance in many machine learning tasks, and handles missing values. The most relevant features per asset type may be selected by generating an artificial feature full of random numbers, training with a tree-based gradient boosting algorithm classifier, and extracting the feature importance. The features whose importance is below the random feature provide less information-gain than a random feature. Thus, the features with importance below the threshold can be dropped. Hyperparameters for each asset type model can be independently tuned using various hyper-parameter optimization algorithms.

In various embodiments the asset type inferring system architecture may include batch jobs in a Spark Scala or pyspark distributed compute pipeline for both model application or inference. The model output may be delivered to an Elastic Search component for use in the search functionality, property cards, and for ownership of our website application and for the API.

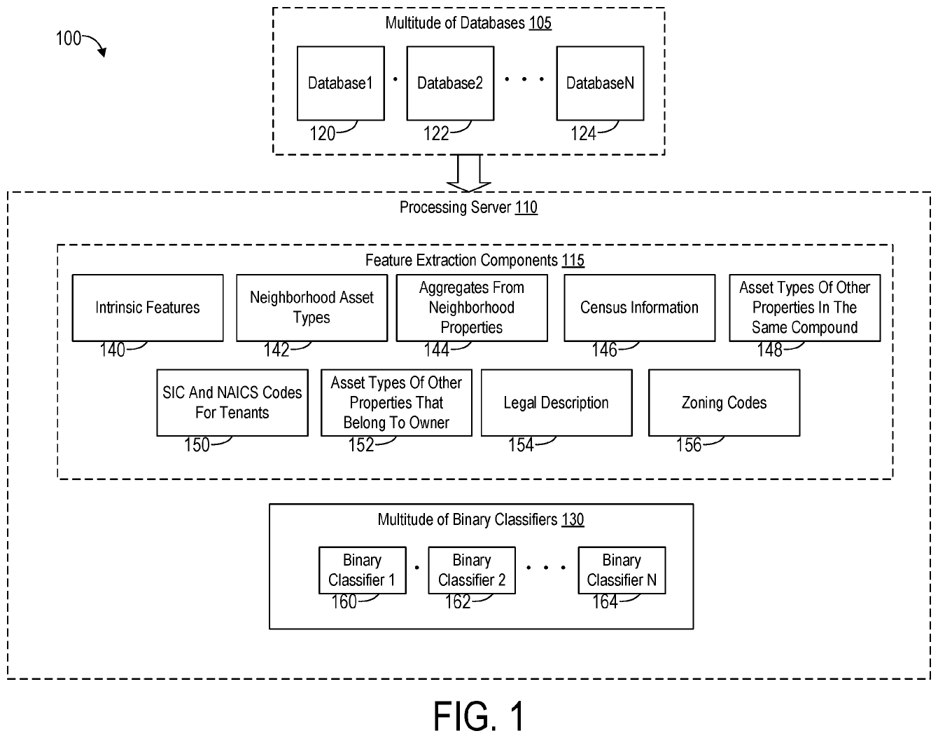

Referring to FIG. 1, FIG. 1 is an illustration of an exemplary embodiment of the asset type inferring system 100. The asset type inferring system 100 may be employed to efficiently ascertain asset types of a large number of properties based on publicly accessible records. The asset type inferring system 100 may scale to be capable of inferring asset types of all the properties of a large geographic area. Further. The asset type inferring system 100 may be efficient such that it may be capable of completing the task without undue computing resources and in a relatively short time. In an exemplary embodiment, the asset type inferring system 100 may be parallelizable such that it may run on multiple computing systems concurrently to speed up the time the asset type inferring system 100 takes to classify properties.

The asset type inferring system 100 may include a multitude of databases 105 and a processing server 110. The multitude of databases 105 may provide property data to the processing server 110. The multitude of databases 105 may represent of variety of databases in the real world. As shown in FIG. 1, database1 120, database2 122, and databaseN may represent any number of databases. The various databases in the multitude of databases 105 may come from any sources and may store data in different formats. Further, the various databases may store different types of data from one another such that the data stored therein is used differently by the asset type inferring system 100. The asset type inferring system 100 automatically adjusts to the varied database types by using multiple feature extraction components. The multiple feature extraction components may be configured to extract meaningful data from each of the multitude of databases 105.

The processing server 110 extracts features from the multitude of databases 105 and processes the features to determine asset types for various properties. The various properties may include the properties from a geographic area. The processing server 110 may determine the asset type of each of the properties. Further, the processing server 110 may determine that properties embody more than one asset types or that the properties have no asset types. Since each property may have more than one asset type, each property is evaluated independently by multiple asset type classifiers. Each of the separate asset type classifiers may determine that the property either IS an asset type or IS NOT an asset type. Thus the asset type classifiers produce a binary product for each asset type.

Various asset types that may be determined by the binary classifiers include, but are not limited to: retail, industrial, office, multifamily, hospitality, public and semi-public, agricultural, easements/other, special purpose, tax exempt, and vacant land. As mentioned above, properties may be determined to have more than one asset type. Further, properties may have no asset type. For instance, a property may be determined to have no asset type if the asset inferring system does not receive enough complete information about a property.

The processing server 110 may include feature extraction components 115 and a multitude of binary classifiers 130. The feature extraction components 115 may specialize in extracting various types of features from the multitude of databases. In various embodiments, multiple feature extraction components 115 may be used on the same database to extract different features for a property. The various feature extraction components 115 may include, but are not limited to: an intrinsic feature extraction component 140, a neighborhood asset type extraction component 142, an aggregates from neighborhood properties extraction component 144, a census information extraction component 146, an asset types of other properties in the same compound extraction component 148, an SIC and NAICS codes of tenants extraction component 150, an asset types of other properties that belong to the same owner extraction component 152, a legal description extraction component 154, and a zoning codes extraction component 156.

The intrinsic features extraction component 140 extracts features that are inherent to a property such as the market value, total area, age of the building, and number of floors in the property. The neighborhood asset types extraction component 142 extracts asset types of neighboring properties. In various embodiments, the neighborhood asset types extraction component 142 may extract asset types of the k closest properties of the property. The asset types of the neighboring properties may be determined by estimating a multinomial distribution over the asset types. Thus, the processing server 110 may create a ten dimensional vector of probabilities for each asset type, the sum of which is 1. Parameters of the multinomial distribution may be estimated using classic statistical inference methods such as Bayesian Inference. In various embodiments, neighboring properties are determined based on a map of the property.

The aggregates from neighborhood properties extraction component 144 determines a combined features of the closest k properties to a property. Examples of aggregate features are the average tax amount, average lot size, and property value to average ratio. The census information extraction component 146 extracts census information such as household size for a property. The asset types of other properties in the same compound extraction component 148 extracts asset types of properties in the same compound or parcel. For instance, the commercial properties that are attached to the same building may be included. The asset types may be determined by estimating a multinomial distribution in the same way that asset types of neighboring properties are determined by the neighborhood asset types extraction component 142 determines asset types.

The SIC and NAICS codes for tenants extraction component 150 extracts business activities of a property from a database. SIC stands for the Standard Industrial Classification. The SIC code comprises a four digit number that categorizes corporations by their business activities. NAICS codes are more prevalent than SIC codes. NAICS stands for the North American Industry Classification System. The NAICS codes comprise 6 digits that classify business activity of a corporation.

The asset types of other properties that belong to owner extraction component 152 extracts asset types of properties that have the same owner. Consideration of properties with a same owner may aid the asset type inferring system 100 in determining an asset type of a property. Similar to the neighborhood asset types extraction component 142, the asset types of other properties that belong to owner extraction component 152 may estimate a multinomial distribution over the asset types and create a 10 dimensional vector of probabilities for each asset type whose sum is 1.

The legal description extraction component 154 extracts a legal description and determines a probability that a property with words in the legal description have an asset type. In an exemplary embodiment, a Correspondence Analysis algorithm is used to compute an association between words in a legal description and asset types of properties. Still, many words in a legal description may not have an association defined by the Correspondence Analysis algorithm. Those words without an association may be represented as features using a Term Frequency Inverse Document Frequency (“TF-IDF”) vectorizer. The TF-IDF vectorizer gives a high weight to words that occur rarely, which are likely to be words that are not defined by the Correspondence Analysis algorithm. In various embodiments, the TF-IDF vectorizer may be trained as 1-gram, 2-gram, or 3-gram.

The features extracted by the Correspondence Analysis algorithm and TF-IDF vectorizer may be used to estimate a probability that the words on a legal description correspond to an asset type of a property. The extracted features may be analyzed by a One-Versus-Rest model for each asset type. The One-Versus-Rest model allows a binary classifier model to work for a multi-class classification, as in the case of classifying multiple asset types. A 10 dimension vector that corresponds to the probability for each asset type may be produced by the One-Versus-Rest model.

The zoning codes extraction component 156 may extract zoning codes for properties. Because various local government entities may use different zoning code systems, the zoning codes extraction component 156 may be configured to account for the disparate systems. In an exemplary embodiment, the zoning codes extraction component 156 may use a combination of zoning code for a state and county to correspond to asset types for properties. The zone codes extraction component 156 may then apply correspondence analysis between asset types and the combination of zoning code, state, and county and uses the scores as features.

The multitude of binary classifiers 130 use the features that are extracted from the feature extraction components 115 to determine asset types for a property. The asset type inferring system 100 may determine multiple asset types for each property, thus the multitude of binary classifiers may each determine a different asset type for the same property. For instance, the binary classifier 1 160 may analyze all of the extracted features from the various feature extraction components to determine a single asset type, such as whether a property is a retail asset type. The binary classifier 2 162 may analyze the same extracted features to determine a separate asset type, such as whether the property is an industrial asset type. The binary classifier N 164 may correspond to the total number of binary classifiers. Each binary classifier in the multitude of binary classifiers 130 may analyze the same extracted features or a subset of the extracted features from the feature extraction components 115 to determine a single asset type.

The various binary classifiers may be trained by machine learning algorithms to determine asset types. Various binary classification algorithms may be implemented as the binary classifiers. Each binary classifier may be separately trained to determine each unique asset type. All of the various extracted features may be used for training each binary classifier.

The binary classifier may incorporate a hyperparameter tuning component. The hyperparameter tuning component may be configured for each binary classifier for the various extracted features. In various embodiments, the hyperparameter tuning component may tune each binary classifier using a hyper-parameter optimization algorithm. Examples of hyper-parameter optimization algorithms are the Tree of Parzen Estimators algorithm, random search, grid search, and various Bayesian optimization algorithms.

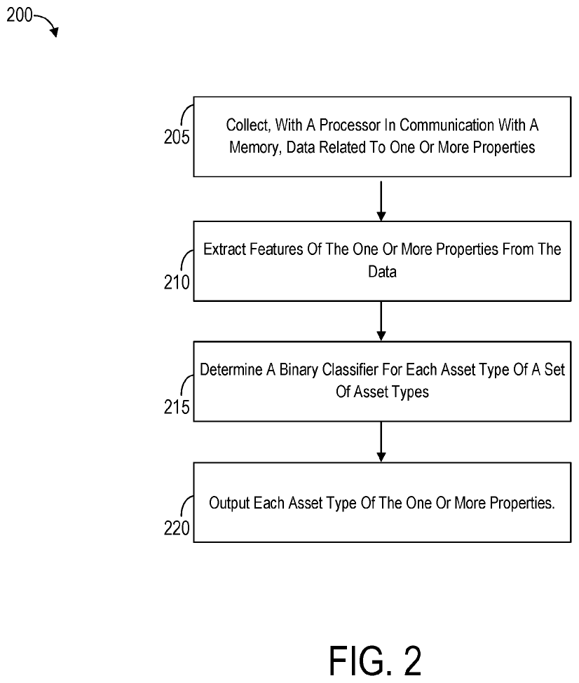

Referring to FIG. 2, FIG. 2 is a flow diagram for a process 200 of determining asset types for one or more properties. The process 200 may be implemented to effectuate commercial research on properties in a large area. The process 200 may determine multiple asset types for a single property. Additionally, the process 200 may determine that a property does not have any asset types. The process 200 includes steps of collecting data from a large number of databases. The data is then extracted with the feature extraction components 115. The extracted features are analyzed by a multitude of binary classifiers 130 to determine the asset types of the property.

At step 205, the process 200 may collect, with a processor in communication with a memory, data related to one or more properties. The data may be collected from a multitude of databases 105, which may store different types of data and store it in various formats. The various databases may include publicly available data such as government records. The process may incorporate various components that are configured to extract meaningful features from the multitude of databases 105.

At step 210, the process 200 may extract features of the one or more properties from the data. A processing server 110 may be used to extract the features by implementing various extraction components, which are configured to extract different types of data. In an exemplary embodiment, the processing employs a separate extraction component to extract features related to intrinsic data of a property, asset types of neighboring properties, aggregate features of neighboring properties taken as a whole, asset types of properties in the same compound, asset types of properties with the same owner, census information, SIC and NAICS codes, legal description data, and zoning code data.

At step 215, the process may determine a binary classifier for each asset type of a set of asset types. The binary classifier may be capable of determining whether a property is an asset type or not. Because there are many potential asset types for any property, a set a binary classifiers are implemented where each binary classifier corresponds to one asset type. The binary classifiers may be trained by a machine learning algorithm. Various machine learning algorithms may be used as the binary classifier. In an exemplary embodiment, a lightGBM, which stands for light gradient boosting machine, algorithm is used to train the binary classifier.

A lightGBM machine learning algorithm is based on decision tree algorithms A decision tree comprises nodes that branch into two nodes based on a condition. Each node may have a different condition. The nodes may successively branch with conditions that are fit to a class. A decision tree may operate on a data record by starting at an input node and traveling down the branches based on conditions of the data record at each node. The class of the data record may be dependent on the final node on which the data record is operated.

Additionally, the machine learning algorithm may have a hyperparameter tuning component. The hyperparameter tuning component may be implemented for each binary classifier. Various models may be used to determine hyperparameters for the binary classifiers. In an exemplary embodiment, a model that implements a Tree-structured Parzen Estimator Approach may be used to determine hyperparameters for each binary classifier.

At step 220, the process may output each asset type of the one or more properties. Each of the determined asset types may be displayed on a list viewable to a user when the property is selected. In various embodiments, the property is displayed on a map at an accurate position relative to other properties. The user may select one of the displayed properties to display the list of its determined asset types.

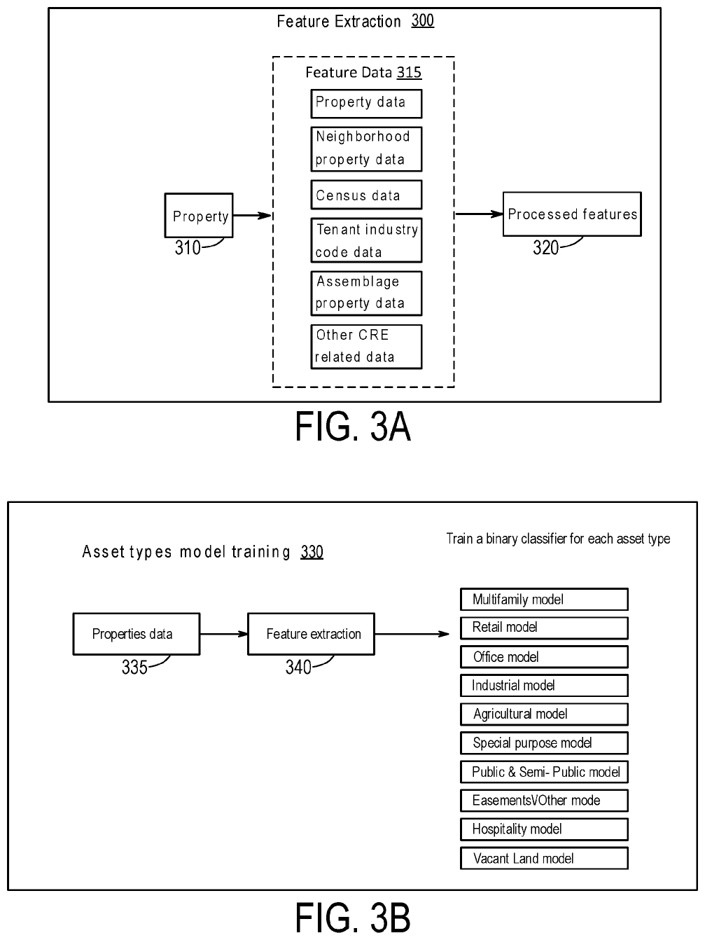

Referring to FIG. 3A, FIG. 3A is a block diagram of a process for feature extraction 300 from a property 310. The process for feature extraction 300 may be implemented on a multitude of databases 105 to extract meaningful data to be analyzed. The meaningful data, hereby referred to as features, is processed by binary classifiers to determine whether the property 310 is an asset type or not.

The property 310 may be real property such as a lot of land, a building, a lease, etc. Data associated with the property 310 is often plentiful, but unorganized. Many databases may contain information related to the property 310 and the information may be useful in different ways depending on the database. Thus, the asset type inferring system 100 includes feature extraction components 115 that are configured to extract feature data 315 from the multitude of databases 105. As shown in FIG. 3A the feature data 315 may include property data, neighborhood property data, census data, tenant industry code data, assemblage property data, and other CRE related data.

The various feature extraction components may be configured to extract data that is specific to a certain feature type. For instance, the intrinsic features extraction component 140 may be configured to extract the property data from the feature data 315. Likewise, the SIC and NAICS codes for tenants extraction component 150 may be configured to extract tenant industry code data from the feature data 315.

Each type of feature data 315 may have a corresponding feature extraction component that is configured to filter and process the property data into processed features. The processed features 320 are analyzed by a multitude of binary classifiers 130. Even though each of the multitude of binary classifiers 130 may determine whether or not the property belongs to a single asset type, each binary classifier may analyze all of the processed features. Thus, a binary classifier, which determines whether the property 310 is retail or not, may analyze each of the categories of feature data.

Referring to FIG. 3B, FIG. 3B is a block diagram for a process 330 for asset types model training. The process 330 may be implemented to train various binary classification models to determine whether a property is an asset type. The property data 335 is collected from the multitude of databases 105. The property data 335 may have known asset types that may be used to train the binary classification models. The feature extraction 340 is performed by the process shown in FIG. 3A. The extracted features may be used to train a binary classification model to determine various asset types of the property based on the property data 335.

Each classifier may be trained using the extracted features. For instance, the 10 classification models shown in FIG. 3B may each be trained with the same feature data, but with different training data for each asset type. Thus, the various models may be trained with the same feature data to compute a binary product that is specific to an asset type. For instance, the multifamily model may be trained with the same feature extraction 340 data as the retail model. On the other hand, the multifamily model may receive training data that is specific to multifamily asset types while the retail model receives retail training data.

Referring to FIG. 3C, FIG. 3C is a block diagram showing a generalized process 350 for a binary classifier training pipeline for a particular asset type. Each binary classifier is a machine learning algorithm that has to be trained. The training pipeline comprises generating training data, selecting important features, training with the training data 368 and testing with the training data 370. Further, depending on the type of machine learning algorithm, the binary classifier may need hyperparameter tuning 372 to efficiently generate an effective training model 374 for the binary classifier.

Each of the models shown in FIG. 3B may be trained according to the generalized process 350. The property features 362 may be extracted from the properties data 360. Training data 364 may be sampled, whereby the labels for the training may be selected. To save computation resources and to improve performance of the model, the most important features may be selected for each binary classification model. Thus, other features may be disregarded for each binary classification model. In an exemplary embodiment, feature importance is extracted by generating an artificial feature full of random numbers and training with a lightGBM classifier. The binary classification model may be trained and tested with the sampled data until the binary classification model performs satisfactorily. Various machine learning models may require a hyperparameter tuning 372 component.

Referring to FIG. 3D, FIG. 3D is a block diagram of a process 380 for model inference. The model inference is the end product of the asset type inferring system 100. It is the final step of predicting an asset type for a property. The other steps of collecting data, extracting features, training a classifier, and hyperparameter tuning allow a binary classifier to predict a probability that a property is an asset type.

Once the binary classifiers are trained, they may be implemented to predict multiple asset types for various properties. As shown in FIGS. 3A-3C, the properties data 392 may be collected from a multitude of databases 105. The feature extraction components 115 in the processing server 110 may perform feature extraction 394 from the data in the multitude of databases 105. Each binary classifier, which corresponds to a separate asset type, may analyze the extracted features to model the probability of each asset type 396.

The binary classifier may determine a probability that a property is an asset type. The probability may be a number between zero and one. Therefore, a threshold must be set to determine whether the probability corresponds to a positive or negative result. The predicted asset type 398 is the positive or negative result, which depends on the threshold.

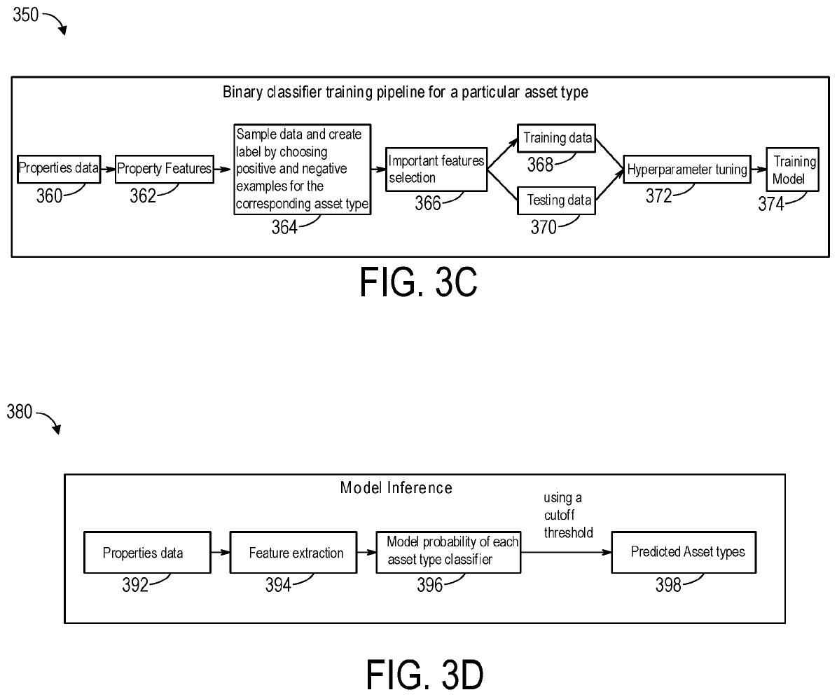

Referring to FIG. 4, FIG. 4 is a model 400 for hyperparameter tuning. Hyperparameters may improve the performance of the binary classifiers that infer asset types and influence the speed and quality of the learning process. As mentioned above, the hyperparameters for each binary classifier may be tuned using hyper-parameter optimization algorithms such as the Tree of Parzen Estimators algorithm, random search, grid search, and various Bayesian optimization algorithms.

The hyperparameters may be tuned by an iterative process shown in FIG. 4. At the start 410 of the process, hyperparameters may be suggested 420 by the algorithm. Next, the binary classifier may train 430 using training data. The training process may take many iterations as well. Next, the binary classifier may be evaluated using testing data. The process may then iterate back to suggesting hyperparameters again. The model 400 may iterate until the binary classifier has the best possible performance.

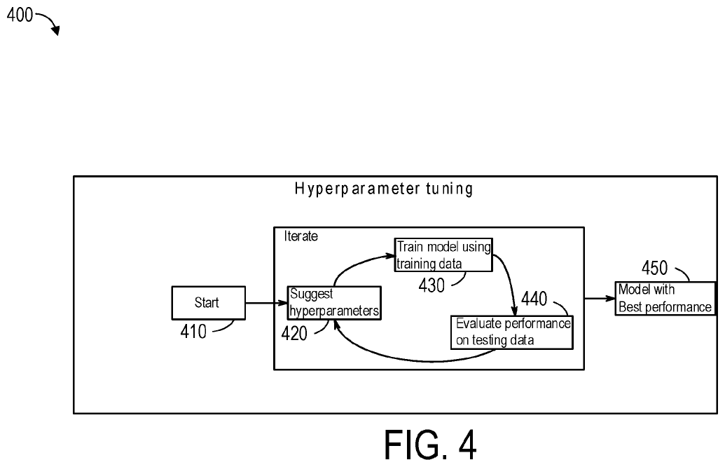

Referring to FIG. 5, FIG. 5 is a process 500 for extracting property features by estimating a multinomial distribution over asset types of other properties. Various feature extraction components may extract features based on the asset types of other properties. For instance, the neighborhood asset types extraction component 142, the asset types of other properties in the same compound extraction component 148, and the asset types of other properties that belong to owner extraction component 152 may extract features based on asset types of other properties.

At step 510, a property is processed to extract features. At step 520, the various extraction components determine which other properties are related to the property. For instance, the neighborhood asset type extraction component 142 determines the k closest properties to the property. At steps 530 and 540, the feature extraction component may estimate a multinomial distribution over asset types by creating a 10 dimensional vector of probabilities for each asset type. A representation of the multinomial distribution over the asset types is shown in FIG. 5.

The multinomial distribution has k possible results, which correspond to the number of possible asset types. Each possible result has an associated probability. As shown in FIG. 5, p1 is the probability that a property is a multifamily asset type, p2 is the probability that a property is a retail asset type, p3 is the probability that a property if the office asset type, p4 is the probability that a property is the industrial asset type, p5 is the probability that a property is the agriculture asset type, p6 is the probability that a property is the vacant land asset type, p7 is the probability that a property is the special purpose asset type, p8 is the probability that a property is the public and semi-public asset type, p9 is the probability that a property is the easements/other asset type, and p10 is the probability that a property is the hospitality asset type. The sum of the associated probabilities equals one and each probability is between zero and one. Classic statistical inference methods such as Bayesian inference may be used to estimate parameters for the multinomial distribution.

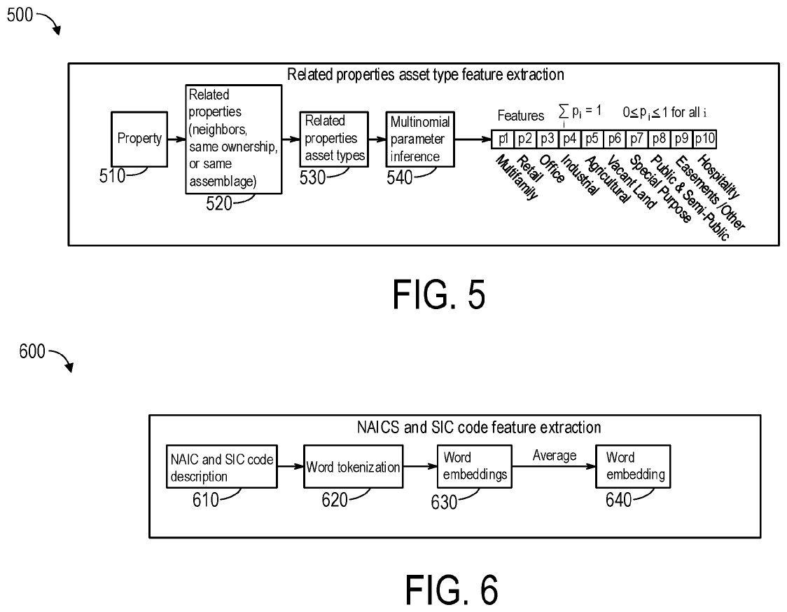

Referring to FIG. 6, FIG. 6 is a block diagram of a process 600 for extracting NAICS and SIC code features from a multitude of databases 105. The North American Classification System (NAICS) and Standard Industrial Classification (SIC) encode business activities of properties in a compact digital code that is six digits for NAICS codes and four digits for SIC codes. The various digital combinations correspond to a description 610 of business activities at the property.

The description 610 may be extracted based on the descriptions provided by the NAICS and SIC systems. The descriptions are mapped, or tokenized 620, to a model. The tokenized descriptions are then applied to a pre-trained embeddings model 630. The embeddings model may map the words of the description from the NAICS or SIC system to a vector. In various embodiments, the tokenized descriptions are mapped to a GloVe embeddings model. A GloVe embeddings model is pre-trained and may have a dimension of 50. The embeddings model computes the average 640 of the embeddings for each word of the descriptions from the NAICS and SIC codes to create an overall sentence embedding of the same dimension.

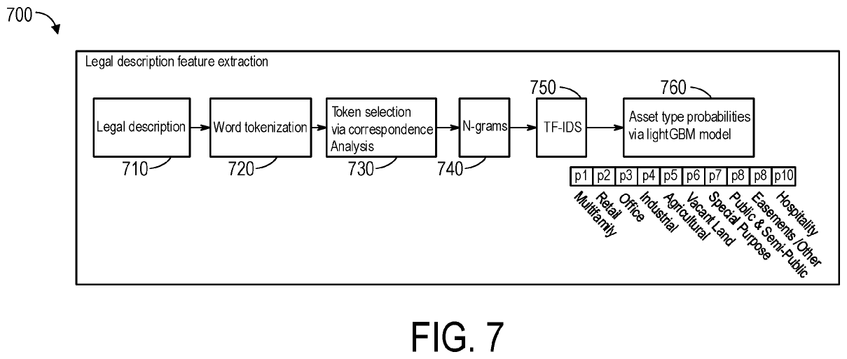

Referring to FIG. 7, FIG. 7 is a block diagram 700 of a legal description feature extraction. Properties may have legal descriptions in various databases. The legal descriptions are in words. The process of extracting the legal description includes converting the words into a probability that the description relates to an asset type. The process is similar to the mapping of the NAICS and SIC codes shown in FIG. 6, whereby the words of the legal description 710 are tokenized 720.

A Correspondence Analysis algorithm may be implemented on the tokenized legal description to define an association of words to the various asset types. The Correspondence Analysis may also be used to select 730 words that cannot be defined. Those undefined words are further processed by a term frequency-inverse document frequency (TF IDF) algorithm. The TF-IDF algorithm may be trained for 1-gram, 2-grams, and 3-grams, meaning that the TF-IDF algorithm is trained for 1 word, 2 word pairs, and three words. Thus, words are paired into N-grams 740 before they are processes by the TF-IDF vectorizer 750. The TF-IDF vectorizer tries to determine the importance of a word to a document (in this case legal description) in a collection by counting how many times a word appears in a document, and is offset by the frequency of the word across the documents.

The Correspondence Analysis algorithm and the TF-IDF algorithm together may generate features that may be used to estimate a probability that a legal description corresponds to an asset type. The probabilities may be estimated by using a One-Versus-Rest model for each of the various asset types. So, for the 10 asset types shown in FIG. 7, 10 probabilities would be estimated using 10 One-Versus-Rest models. Any binary classifier may be used with the One-Versus-Rest model. In various embodiments, the binary classifier is a lightGBM model.

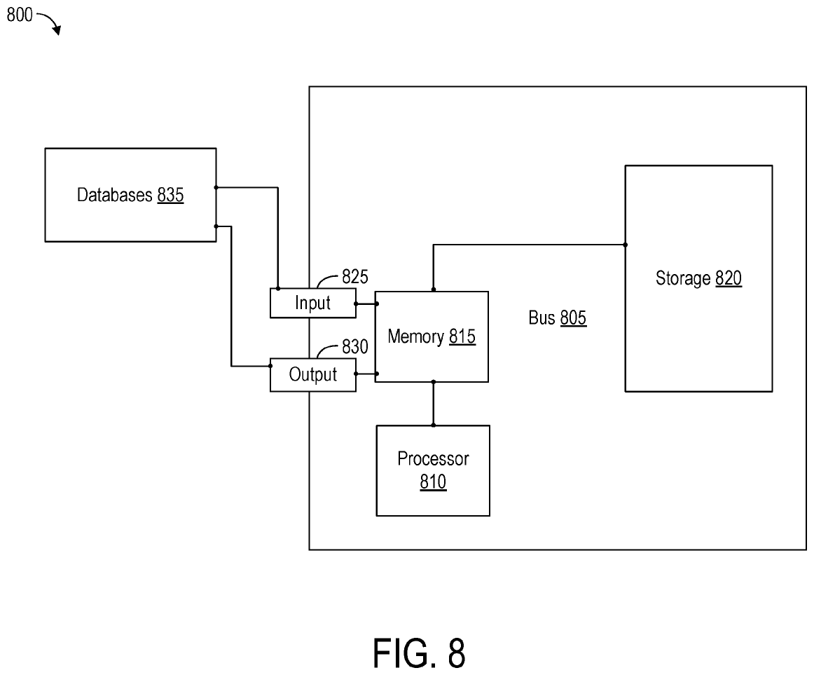

Referring to FIG. 8, FIG. 8 is an illustration of a computer system 800 that may perform the disclosed process of inferring asset types. The computer system 800 may be a single computer system, a co-located system, a cloud-based system, a distributed system, or the like. The computer system 800 may direct other computers in a distributed compute network to complete various processing tasks such as performing an analysis on various records.

The various components of the computer system 800 may be linked by a bus 805 that connects them together. The bus 805 may connect various components based on the requirements of the components. For instance the processor 810 may be connected to the memory 815 through a high speed bus 805 connection. The processor 810 executes instructions that are transmitted to the processor 810 from the memory 815. The processor 810 may be a central processing unit (CPU), a graphics processing unit (GPU), a complex programmable logic device (CPLD), a field programmable gate array (FPGA), an application-specific integrated chip (ASIC), and the like. The instructions that are executed by the processor 810 may be transmitted through the memory 815 to various other components of the computer system 800.

The memory 815 transmits instructions to be executed to the processor 810 and transmits executed instructions from the processor 810 to the various components of the computer system 800. Types of memory include random access memory (RAM) and read only memory (ROM). The memory 815 may generally direct the operation of the computer system 800 as most data will be transmitted through the memory 815 on its way to other components of the computer system 800. Data may be stored in a storage 820 for long periods without losing the data if the computer system 800 is powered down. Types of storage may include a spinning magnetic drive and flash storage.

Data and instructions from outside the computer system 800 may be transmitted to the memory 815 through an input. For example, records from databases 835 may be collected through connections that traverse to the memory 815 through the input 825. The computer system may be configured to output one or more determined asset types of a property. In various embodiments, the output comprises a geographic map of properties that are selectable by a user.

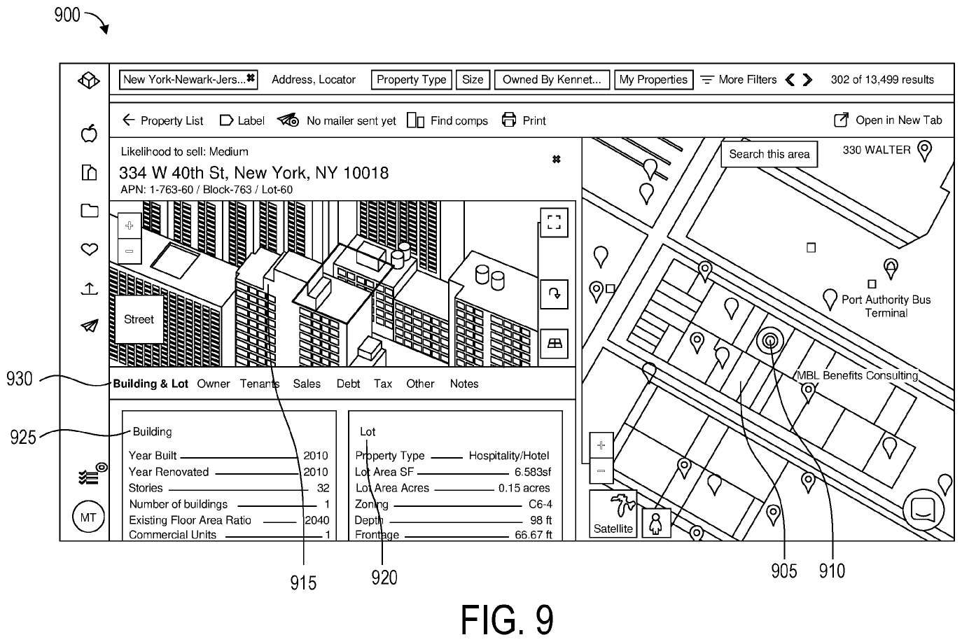

Referring to FIG. 9, FIG. 9 is a screen shot 900 illustrating how asset types may be displayed in a user interface to understand the characteristics of a property. As shown in FIG. 9, properties may be selectable on a map 905. Once a property 910 is selected, the property information may be displayed to the side of the map.

For example, a satellite image 915 of the selected property 910 is shown in the top left corner of the screen shot 900. Below the satellite image 915 may be selectable tabs 930 that, when selected, display various property information under the satellite image 915. In the screen shot 900, the building and lot tab is selected. The building characteristic information 925 is displayed showing the year built, year renovated, stories, number of buildings, existing floor area ratio, and commercial units. The lot characteristic information 920 is displayed showing the property type, lot area in square feet and in acres, zoning, depth, and frontage.

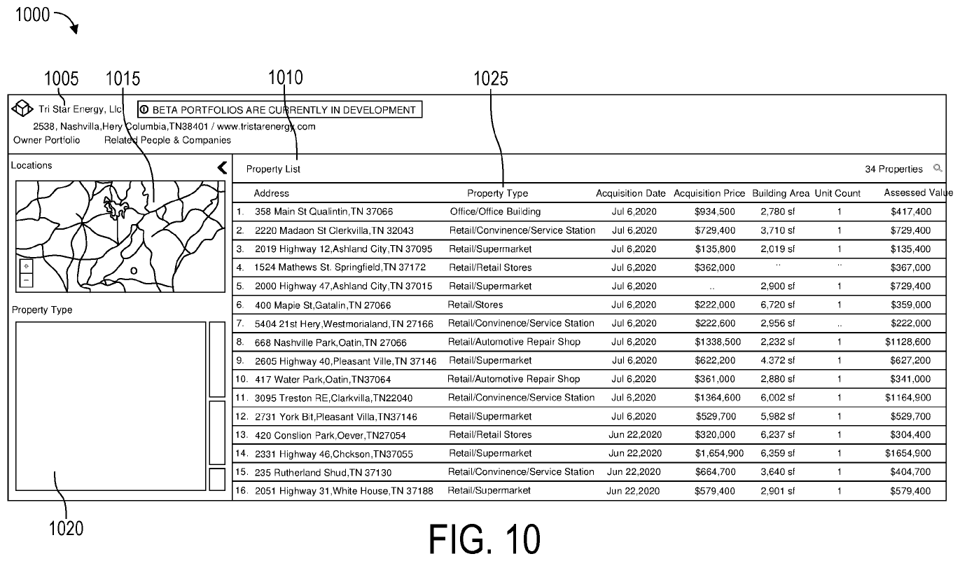

Referring to FIG. 10, FIG. 10 is a screen shot 1000 of an exemplary embodiment of a user interface that presents the asset types for an entity such as a corporation or an individual. The user interface may display the entity name 1005 which is shown at the top of the screen shot 1000. The list of properties 1010 that are owned by the entity are shown on the right side of the screen shot 1000. Various property characteristics are presented for each property. For instance, the asset type(s) 1025 for each property is displayed in one column of the list of properties 1010.

Additionally, a map 1015, which shows the locations of the properties on the list of properties 1010, is presented in the top left of the screen shot 1000. Further, a graphic display 1020 shows a size of fractional values of each property asset type owned by the entity. In this screen shot, the entity is a corporation that is primarily invested in retail, but also has a few properties invested in office.

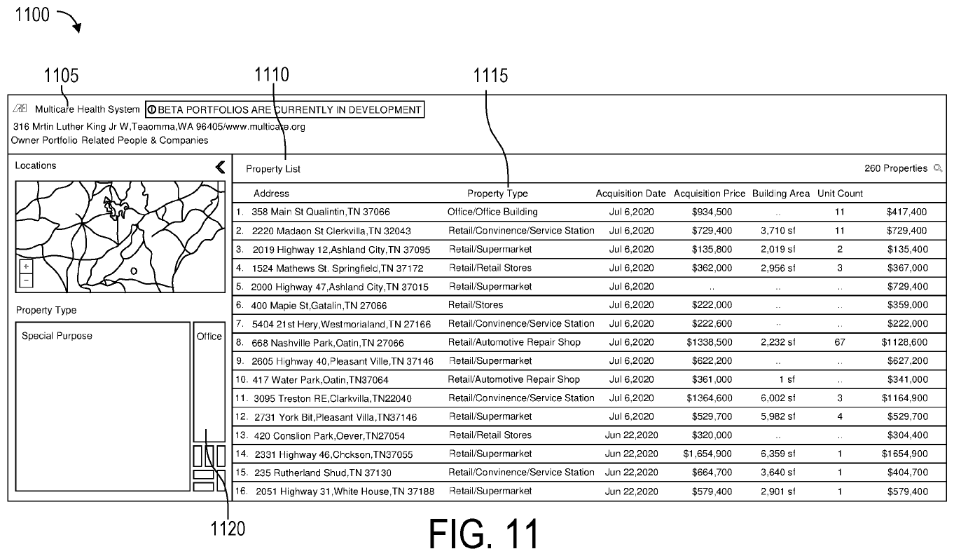

Referring to FIG. 11, FIG. 11 is a screen shot 1100 of another exemplary embodiment of a user interface that presents the asset types for an entity such as a corporation or an individual. Like the screen shot 1000 in FIG. 10, the screen shot 1100 in FIG. 11 shows a list of properties 1110 that are owned by a corporation 1105. The list of properties 1110 show the asset type for each property. The fractional value 1120 of each property asset type shows that the corporation 1105 is primarily invested in the special purpose category of property types which are primarily used for tax exempt institutions, but also has a few properties of the office asset type and others.

There are many business reasons for a user to understand the asset type profile of a property owner. One use case is where the user has expertise in transacting on one asset type and wants to find entities that predominantly own the asset type where the user has expertise. Another use case is where the user wants to evaluate the risk of an owner portfolio. For example, retail assets may suffer while multifamily assets grow depending on the economic climate. Thus, understanding the diversity of a property portfolio may help users understand the entities that may be cash rich or poor, or who may be open to selling a property or a portfolio.

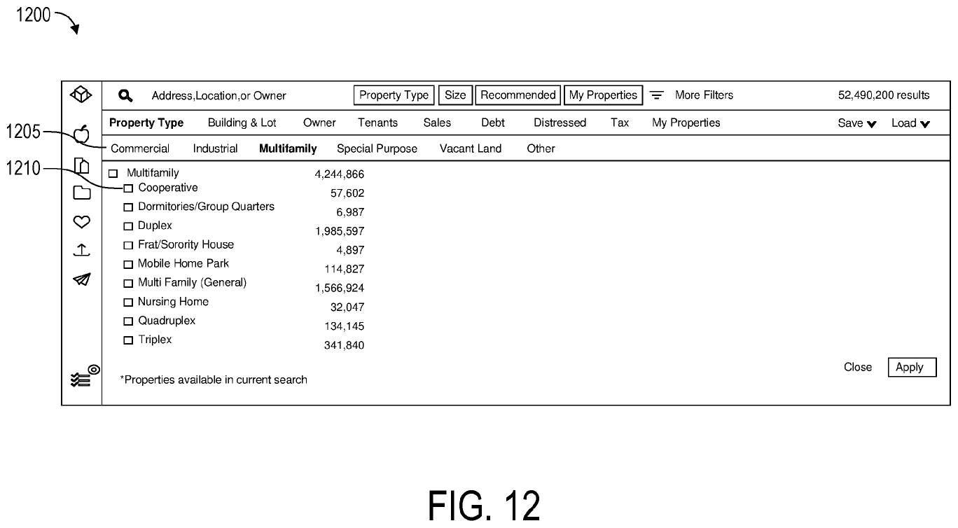

Referring to FIGS. 12-17, FIGS. 12-17 are screen shots that illustrate how a user may use a search functionality to select one or more asset types for discovery. Given that different asset types have different and independent economic performance, e.g. one asset type may be growing while another is failing, users may prefer to focus on one asset type at a time. Users may also develop expertise in one or a few asset types. This makes the asset type a primary point of entry for discovery of properties.

For instance, the screen shot 1200 of FIG. 12 shows a list 1210 of the multifamily asset types for a search. The multifamily asset types may be selected from a tab 1205 of various asset types. As shown in the screen shot 1200, the asset type may be sub-divided into various sub-categories within the asset type. In this instance, the multifamily asset type in the screen shot 1200 shows the sub-categories of cooperative, dormitories/group quarters, duplex, frat/sorority house, mobile home park, nursing home, quadruplex, and triplex.

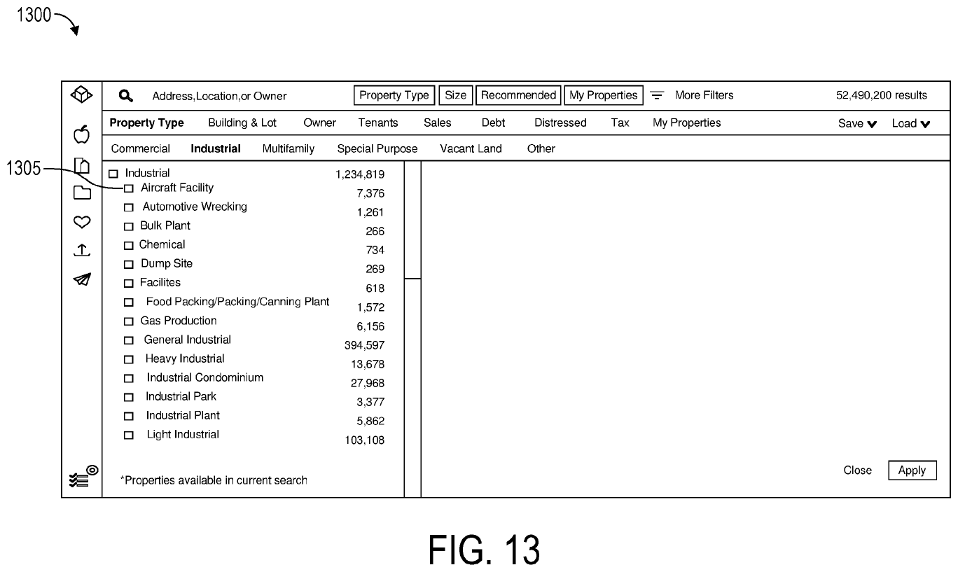

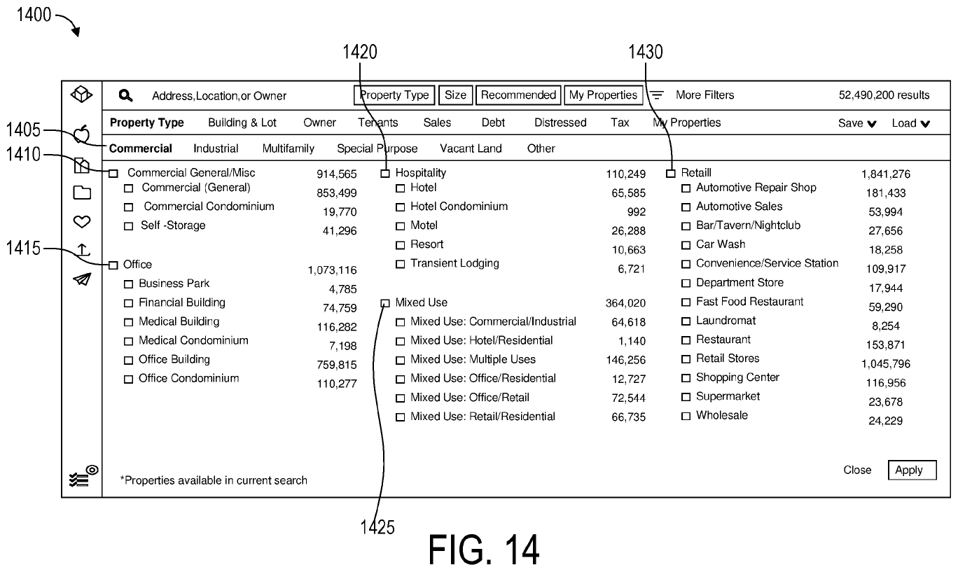

FIG. 13 is a screen shot 1300 that shows a list 1305 of properties that are classified as the industrial asset type by a binary classifier of the asset type inferring system 100. FIG. 14 is a screen shot 1400 that shows lists of properties that are classified as the commercial asset type. As shown in FIG. 14, the commercial asset type may be divided into multiple asset types that are classified as commercial. For instance, a selection of the commercial asset type tab 1405 may display properties in a search that are classified as commercial general/misc. 1410, office 1415, hospitality 1420, mixed use 1425, and retail 1430.

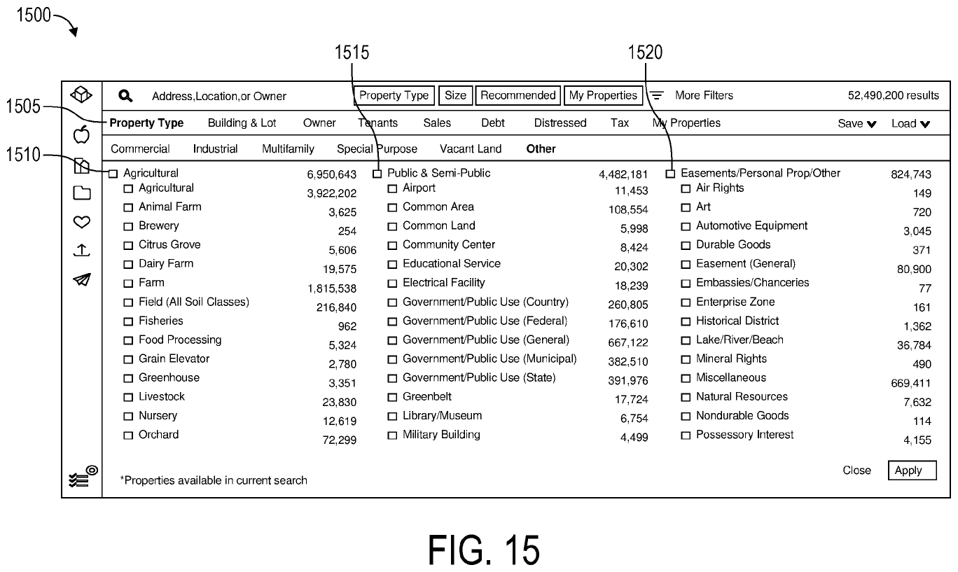

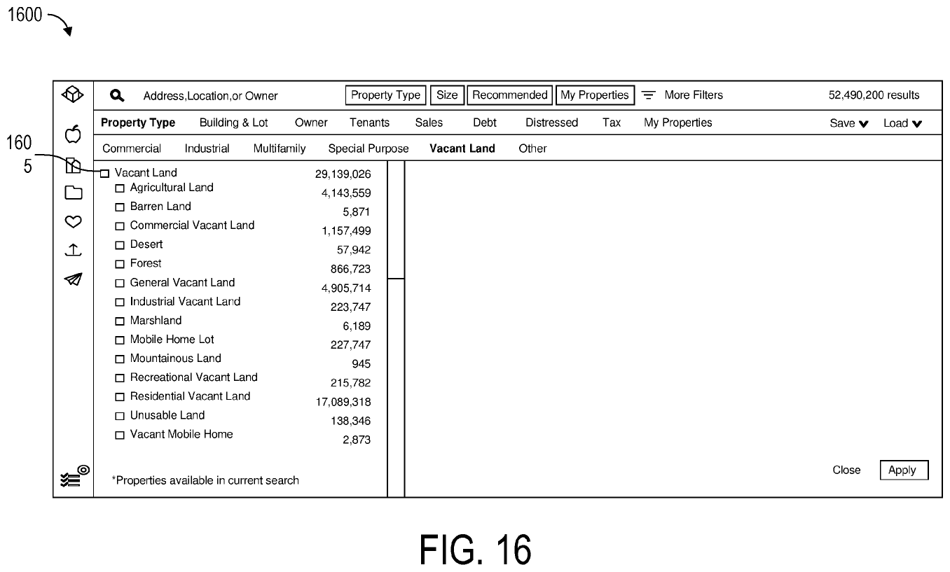

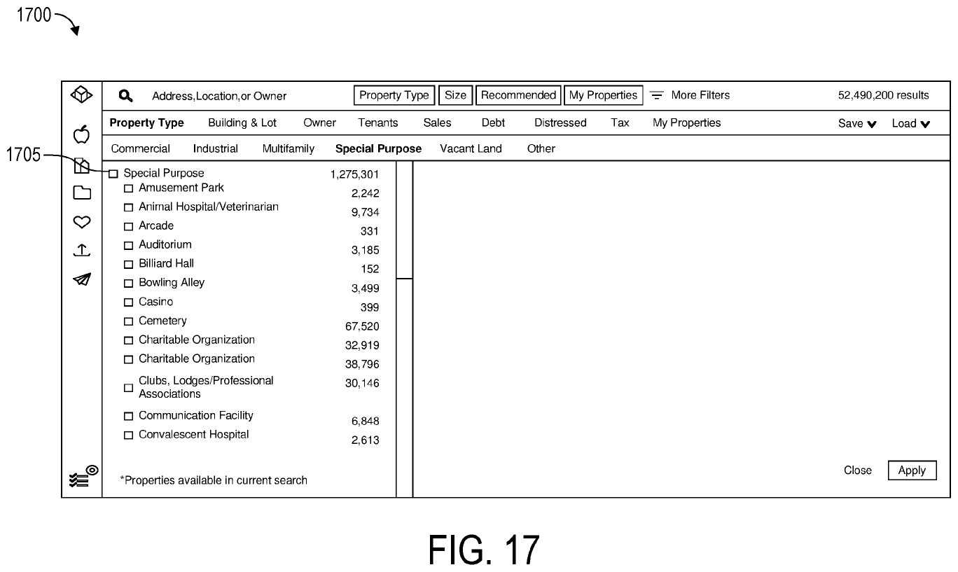

Likewise, a selection of the other tab 1505 in the screen shot 1500 of FIG. 15 may present multiple asset types within the other asset type category. The list of sub-asset types in the screen shot 1500 includes agricultural 1510, public and semi-public 1515, and easements/personal property 1520. The screen shot 1600 in FIG. 16 presents a list 1605 of vacant land properties and the screen shot 1700 in FIG. 17 presents a list 1705 of special purpose properties. Note that each asset type is divided into multiple sub-categories.

Many variations may be made to the embodiments described herein. All variations are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for determining asset types of one or more properties, the method comprising:
collecting data, with a processor in communication with a memory, related to the one or more properties;
extracting features, by the processor, of the one or more properties from the data;
determining, by the processor, a binary classifier for each asset type of a set of asset types; and
outputting, by the processor, each asset type of the one or more properties.

2. The method of claim 1, wherein extracting comprises determining one or more words in a description.

3. The method of claim 1, wherein determining the binary classifier comprises determining a probability that each asset type is attached to a property.

4. The method of claim 1, wherein the features comprise asset types of neighboring properties.

5. The method of claim 1, wherein the features comprise aggregates of features from two or more neighboring properties.

6. The method of claim 4, wherein the asset types of neighboring properties are determined by estimating a multinomial distribution over all asset types.

7. The method of claim 1, wherein the binary classifier is trained by a machine learning algorithm.

8. A computing system, with a processor in communication with a memory, for determining asset types of one or more properties, the computing system comprising:
a processing server configured to collect data related to the one or more properties;
the processing server configured to extract features of the one or more properties from the data;
the processing server configured to determine a binary classifier for each asset type of a set of at least one asset types; and
the processing server configured to output each asset type of the one or more properties.

9. The computing system of claim 8, wherein extracting comprises determining one or more words in a description.

10. The computing system of claim 8, wherein determining the binary classifier comprises determining a probability that each asset type is attached to a property.

11. The computing system of claim 8, wherein the features comprise asset types of neighboring properties.

12. The computing system of claim 8, wherein the features comprise aggregates of features from two or more neighboring properties.

13. The computing system of claim 11, wherein the asset types of neighboring properties are determined by estimating a multinomial distribution over all asset types.

14. The computing system of claim 8, wherein the binary classifier is trained by a machine learning algorithm.

15. A computer readable storage medium, with a processor in communication with a memory through a bus, having data stored therein representing a software executable by a computer, the software comprising instructions that, when executed, cause the computer to perform:
collecting data related to one or more properties;
extracting features of the one or more properties from the data;
determining a binary classifier for each asset type of a set of at least one asset types; and
outputting, by the processor, each asset type of the one or more properties;
wherein the outputting comprises a display of a geographic map with the one or more properties; and
wherein the one or more properties are selectable by a user.

16. The computer readable storage medium of claim 15, wherein extracting comprises determining one or more words in a description.

17. The computer readable storage medium of claim 15, wherein determining the binary classifier comprises determining a probability that each asset type is attached to a property.

18. The computer readable storage medium of claim 15, wherein the features comprise asset types of neighboring properties.

19. The computer readable storage medium of claim 15, wherein the features comprise aggregates of features from two or more neighboring properties.

20. The computer readable storage medium of claim 18, wherein:
the asset types of neighboring properties are determined by estimating a multinomial distribution over all asset types; and
the binary classifier is trained by a machine learning algorithm.
